(19) United States
(12) Patent Application Publication
(10) Pub. No.: US 2026/0194550 A1
(43) Pub. Date: Jul. 9, 2026

(54) DISPOSABLE CARTRIDGE FOR A TESTING DEVICE

(71) Applicant: SiPhox, Inc., Burlington, MA (US)

(72) Inventors: Diedrik Vermeulen, Arlington, MA (US); John McCormack, Hedehusene (DK); Trey Wheelahan, Watertown, MA (US)

(73) Assignee: SiPhox, Inc., Burlington, MA (US)

(21) Appl. No.: 19/440,444

(22) Filed: Jan. 5, 2026

Related U.S. Application Data
(63) Continuation-in-part of application No. 19/252,055, filed on Jun. 27, 2025.
(60) Provisional application No. 63/741,556, filed on Jan. 3, 2025.
(60) Provisional application No. 63/741,568, filed on Jan. 3, 2025.
(60) Provisional application No. 63/741,661, filed on Jan. 3, 2025.
(60) Provisional application No. 63/741,611, filed on Jan. 3, 2025.
(60) Provisional application No. 63/742,184, filed on Jan. 6, 2025.
(60) Provisional application No. 63/742,578, filed on Jan. 7, 2025.
(60) Provisional application No. 63/742,696, filed on Jan. 7, 2025.

(51) Int. Cl. G01N 35/10; G01N 35/00

(52) U.S. Cl. CPC G01N 35/10; G01N 35/00732; G01N 2035/1027

(57) ABSTRACT

A disposable cartridge for a home testing device includes a housing, a fluidic component including at least an input port, at least a flow channel, and a sensor chamber communicatively connected to a reader device, at least a reagent supply component having at least a well containing at least a reagent, a sample source containing a biological sample, and at least a pipette is movable relative to the reagent supply component and the fluidic component between a reagent collection position wherein the distal port is inserted into a well of the at least a well and an ejection position wherein the distal port is inserted into the at least an input port, and the at least a pipette is configured to provide the at least a reagent and the biological sample to the at least an input port.

### CROSS-REFERENCE TO RELATED APPLICATIONS

This application claims the benefit of priority of U.S. Provisional Patent Application Ser. No. 63/742,578, filed on Jan. 7, 2025, and titled “METHOD FOR THE MEASUREMENT OF SERUM LEVELS OF TWENTY HUMAN BIOMARKERS USING FOUR SILICON PHOTONIC CHIPS,” which is incorporated by reference herein in its entirety. This application claims the benefit of priority of U.S. Provisional Patent Application Ser. No. 63/742,696 filed on Jan. 7, 2025, and titled “MICROFLUIDICS ARCHITECTURE FOR A DISPOSABLE CARTRIDGE IN A HOME TESTING DEVICE,” which is incorporated by reference herein in its entirety. This application claims the benefit of priority of U.S. Provisional Patent Application Ser. No. 63/742,184, filed on Jan. 6, 2025, and titled “NOVEL USER-FRIENDLY HOME BLOOD COLLECTION AND TESTING SYSTEM WITH DIRECT-MATING CARTRIDGE AND READER,” which is incorporated by reference herein in its entirety. This application claims the benefit of priority of U.S. Provisional Patent Application Ser. No. 63/741,556, filed on Jan. 3, 2025, and titled “CHEMICAL AMPLIFIER FOR IMMUNOASSAY ON NANOPHOTONIC CHIP,” which is incorporated by reference herein in its entirety. This application claims the benefit of priority of U.S. Provisional Patent Application Ser. No. 63/741,568, filed on Jan. 3, 2025, and titled “INTEGRATED PHOTONICS TURBIDIMETRY,” which is incorporated by reference herein in its entirety. This application claims the benefit of priority of U.S. Provisional Patent Application Ser. No. 63/741,661, filed on Jan. 3, 2025, and titled “POLARIZATION-SWITCHABLE TIME-MULTIPLEXED PHOTONIC CHIP FOR MULTIPLEXED BIOSENSING APPLICATIONS,” which is incorporated by reference herein in its entirety. This application is a continuation in part of U.S. Nonprovisional application Ser. No. 19/252,055, filed on Jun. 27, 2025 and entitled “DEVICE FOR MULTIPLEXED OPTICAL BIOSENSING,” which is incorporated herein by reference in its entirety, and which claims the benefit of priority of U.S. Provisional Patent Application Ser. No. 63/741,611, filed on Jan. 3, 2025, and titled “MULTIPLEXED PHOTONIC BIOSENSORS,” which is incorporated by reference herein in its entirety.

### FIELD OF THE INVENTION

The present invention generally relates to the field of home diagnostic equipment. In particular, the present invention is directed to a disposable cartridge for a home testing device.

### BACKGROUND

Recent advancements in home diagnostics require compact, reliable, and affordable systems to perform various assay workflows. A key requirement in these systems is the efficient manipulation and processing of blood or other biofluid samples, involving sample extraction, sample cleanup, serum or plasma separation, sample splitting, metering, reagent mixing, and multi-stage dilutions. The traditional lab-based systems are unsuitable for home diagnostics due to their complexity, cost, and size.

### SUMMARY OF THE DISCLOSURE

In an aspect, a disposable cartridge for a home testing device includes a housing, a fluidic component disposed within the housing, the fluidic component comprising at least an input port configured to receive fluid, at least a flow channel fluidically connected to the at least an input port, and a sensor chamber fluidically connected to the at least a flow channel, the sensor chamber communicatively connected to a reader device, at least a reagent supply component disposed within the housing and comprising at least a well, the at least a well containing at least a reagent, a sample source disposed within the housing and containing a biological sample, and at least a pipette disposed within the housing and having a tip with distal port, wherein the at least a pipette includes an internal channel having a proximal end and a distal end, the proximal end is connected to an actuable pressurized fluid supply, the distal end is connected to the output hole, the at least a pipette has a suction mode for receiving fluid into the internal channel through the distal port and an ejection mode for forcing fluid out of the internal channel through the distal port, the at least a pipette is movable relative to the reagent supply component and the fluidic component between a reagent collection position wherein the distal port is inserted into a well of the at least a well and an ejection position wherein the distal port is inserted into the at least an input port, and the at least a pipette is configured to provide the at least a reagent and the biological sample to the at least an input port.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic diagram illustrating an exemplary embodiment of a cartridge;

FIG. 2A is a flow diagram illustrating an exemplary embodiment of a microfluidic architecture;

FIG. 2B is a flow diagram illustrating an exemplary embodiment of a microfluidic architecture;

FIG. 3 is a flow diagram illustrating an exemplary embodiment of a microfluidic architecture;

FIG. 4 is a schematic diagram illustrating an exemplary embodiment of a cartridge;

FIG. 5 is a schematic diagram illustrating an exemplary embodiment of a cartridge;

FIG. 6 is a schematic diagram illustrating an exemplary embodiment of a cartridge;

FIG. 7 is a schematic diagram illustrating an exemplary embodiment of a cartridge;

FIG. 8 is a schematic illustration of an exemplary configuration of a cartridge;

FIG. 9 is a schematic illustration of an exemplary configuration of a cartridge;

FIG. 10 is a schematic illustration of an exemplary configuration of a cartridge;

FIG. 11 is a schematic illustration of an exemplary configuration of a cartridge;

FIG. 12 is a schematic illustration of an exemplary configuration of a cartridge;

FIG. 13 is a schematic illustration of an exemplary configuration of a cartridge;

FIG. 14 is a schematic illustration of an exemplary configuration of a cartridge;

FIG. 15 is a schematic illustration of an exemplary configuration of a cartridge;

FIG. 16 is a schematic illustration of an exemplary configuration of a cartridge;

FIG. 17 is a schematic illustration of an exemplary configuration of a cartridge;

FIG. 18 is a schematic illustration of an exemplary configuration of a cartridge;

FIG. 19 is a schematic illustration of an exemplary configuration of a cartridge;

FIG. 20 is a schematic illustration of an exemplary configuration of a cartridge;

FIG. 21 is a schematic illustration of an exemplary configuration of a cartridge;

FIG. 22 is a schematic illustration of an exemplary configuration of a cartridge;

FIG. 23 is a schematic illustration of an exemplary configuration of a cartridge;

FIG. 24 is a schematic illustration of an exemplary configuration of a cartridge;

FIG. 25 is a schematic illustration of an exemplary configuration of a cartridge;

FIG. 26 is a schematic illustration of an exemplary configuration of a cartridge;

FIG. 27 is a schematic illustration of an exemplary configuration of a cartridge;

FIG. 28 is a schematic illustration of an exemplary configuration of a cartridge;

FIG. 29 is a schematic illustration of an exemplary configuration of a cartridge;

FIG. 30 is a schematic illustration of an exemplary configuration of a cartridge;

FIG. 31 is a schematic illustration of an exemplary configuration of a cartridge;

FIG. 32 is a schematic illustration of an exemplary configuration of a cartridge; and

FIG. 33 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

Embodiments described herein provide novel microfluidics architectures specifically designed for a disposable cartridge within a home testing and home collection device of biofluids, such as without limitation capillary whole blood. Cartridge architectures described herein may support a range of macro and microfluidic functions usable for assays, such as, without limitation: (1) Serum or Plasma Separation including initial separation of the blood sample into serum or plasma components; (2) Sample Splitting and Metering including controlled division and metering of the sample into portions for different assay processes; Sample Dilutions and Mixing including precision dilution of samples through staged mixing, including reconstitution of lyophilized beads for reagent preparation; and/or (3) Fluid Flow and Washing Steps including directed flow of prepared liquids over a chip, including essential washing steps with buffer solutions for assay accuracy.

In some embodiments, microfluidics architecture may include a plurality of parallel microfluidics lanes, such as without limitation four parallel microfluidics lanes, within a flow cell to enhance throughput and support multiple assays simultaneously. Embodiments may enable assays on and collection of biofluids such as but not limited to blood, plasma, saliva, sweat, urine, digestive fluids, semen, lymph, vaginal secretions, amniotic fluid, cerebrospinal fluid, and/or any other fluids extracted from a biological organism and/or one or more parts or organs thereof.

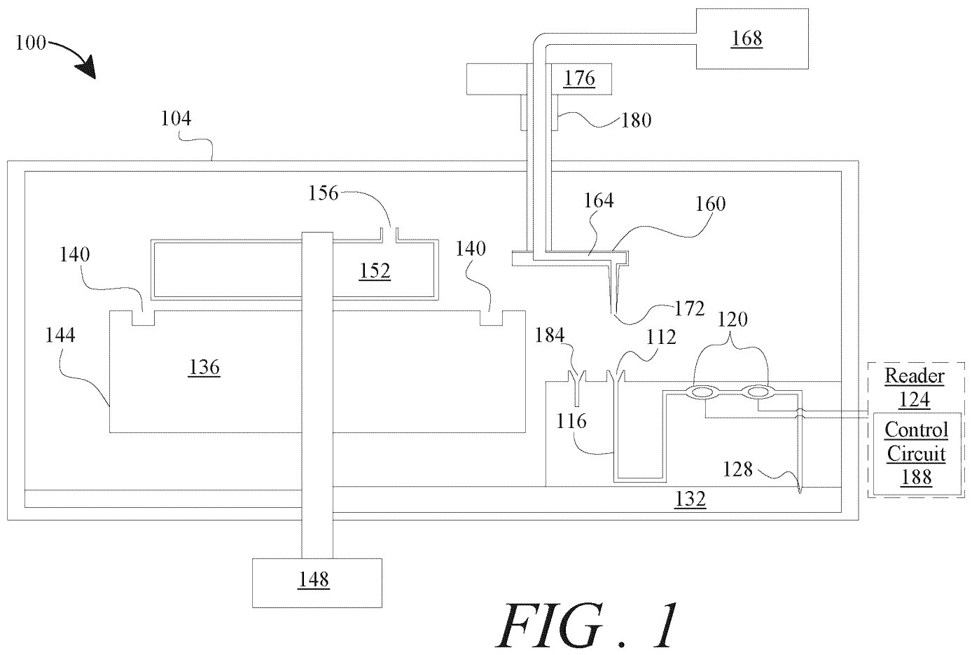

Referring now to FIG. 1, an exemplary embodiment of a disposable cartridge 100 100 for a home testing device is illustrated. Cartridge 100 includes a housing 104. Housing 104 may be composed of any suitable material or combination of materials, including without limitation metal such as steel, aluminum, titanium or the like, natural and/or artificial polymer materials such as plastic and/or rubbers, or the like. Housing 104 may include one or more apertures, openings, lids, or the like; for instance and without limitation, housing 104 may include an aperture for insertion of a collection tube or other vessel containing a sample, which may be closable using a lid, sliding element, or the like. Housing 104 may include one or more mechanical interfaces where a motor, gears, mechanical couplings, or the like may connect to elements described below such as pipettes 160 and/or carousels 144 for the purposes of moving such elements rotationally, horizontally, and/or vertically. Housing 104 may alternatively or additionally be formed to include reservoirs and other elements as described in further detail below.

Housing 104 may include a sliding cover; guide rails and alignment features may ensure robust sliding of the lid. There may also be latch features preventing the lid from opening or sliding back. A sliding lid on the top surface may protect pipetting elements prior to cartridge 100 use, protect the central spindle hole, and/or prevent user access to elements within cartridge 100 once inserted. In embodiments, sliding lid may be operated by a user, moving from a “storage” position to an “engaged” position. Sliding lid may run along two parallel guide rails on the cartridge 100 top cover. Both rails may prevent cover being lifted from cartridge 100 in the Z-axis, with only one of the rails providing guidance for the sliding motion. This arrangement may keep a high aspect ratio to prevent binding during use. Bump features in rail and lid may provide a resistance to sliding motion when in storage position to protect against early/accidental closing. Latch features in rail and lid provide a non-reversible resistance to sliding motion when in engaged position. This may prevent reopening of sliding lid after closure and use. Cartridge 100 may include an upper surface potentially positioned under a sliding lid as described above, with cutouts for tube insertion and microfluidic pipette 160 interaction by a reader 124.

Still referring to FIG. 1, cartridge 100 includes a fluidic component 108 disposed within the housing 104. Fluidic component 108 includes at least an input port 112 configured to receive fluid. Fluidic component 108 includes at least a flow channel 116 fluidically connected to the at least an input port 112. Fluidic component 108 includes a sensor chamber 120 fluidically connected to the at least a flow channel 116, the sensor chamber 120 communicatively connected to a reader 124 device; sensor chamber 120 may include, without limitation, an electrooptical device such as a ring resonator or similar structure as described in U.S. Nonprovisional application Ser. No. 17/859,877, filed on Jul. 7, 2022 under attorney docket number 1214-004USU1 and entitled “DEVICES, SYSTEMS, AND METHODS FOR RESPIRATORY DISEASE TESTING,” the entirety of which is incorporated herein by reference, and/or other sensors as described in U.S. Nonprovisional application Ser. No. 19/252,055, including without limitation resonators and/or interferometers. Aspects of reader 124 component and/or device may be implemented, without limitation, as described in U.S. Nonprovisional application Ser. No. 19/079,377, filed on Mar. 21, 2023 with attorney docket number 1214-009USU1 and entitled “OPTICAL READER 124 DEVICE FOR MULTIPLEXED DIAGNOSTIC SYSTEMS AND METHODS OF USE,” the entirety of which is incorporated herein by reference. Aspects of sensor component may be implemented, without limitation, and/or as described in U.S. Nonprovisional application Ser. No. 18/126,014, filed on Mar. 24, 2023 with attorney docket number 1214-010USU1 and entitled “PHOTONIC BIOSENSOR FOR MULTIPLEXED DIAGNOSTICS AND A METHOD OF USE,” the entirety of which is incorporated herein by reference. One or more flow channels 116 located in a flow component may be connected fluidically to one or more flow channels 116 of a reader 124 component or other portion of a system and/or device incorporating components as described in this disclosure; fluids may be moved through fluidics channels and/or channels connected thereto by active or passive means, for instance and without limitation as described in U.S. Nonprovisional application Ser. No. 17/859,932, filed on Jul. 7, 2022 with attorney docket number 1214-005USU1 and entitled “SYSTEMS AND METHODS FOR FLUID SENSING USING PASSIVE FLOW,” the entirety of which is incorporated herein by reference, and in U.S. Nonprovisional application Ser. No. 18/107,135, filed on Feb. 18, 2023 with attorney docket number 1214-007USU1 and entitled “APPARATUS AND METHODS FOR ACTUATING FLUIDS IN A BIOSENSOR CARTRIDGE 100,” the entirety of which is incorporated herein by reference. At least a flow channel 116 may include at least a microfluidic channel. At least a sensor chamber 120 may include a plurality of sensor chambers 120 per flow channel 116. At least a flow channel 116 may include a waste fluid waste outlet port 128, defined as a port through which fluid can exit at least a flow channel 116, for instance when pushed out by pressure from a pump or other actual pressurized water source such as during rinse or wash steps as described in further detail below. Waste fluid waste outlet port 128 may include a one-way valve and/or a valve that is closed except when subjected to pressure in excess of a threshold amount, such as a poppet valve, check valve, slit valve, or the like. In some embodiments, housing 104 may include a waste reservoir 132 fluidically connected to waste fluid waste outlet port 128; waste reservoir 132 may include any cavity, container, or hollow space able to accept fluid from waste fluid waste outlet port 128. In embodiments, fluidic component 108 may function as a primary site for fluid movement and sample processing. In some embodiments, architecture may allow for four microfluidics lanes, which support parallel processing and increased throughput. In one embodiment fluidic component 108 may contain a silicon photonics chip with multiple biosensor elements per lane, for instance and without limitation as described in disclosures incorporated by reference herein.

Further referring to FIG. 1, a reader 124 may interface with cartridge 100 in any of several ways. Interfaces may include optical and electrical interfaces, for instance and without limitation including waveguides, waveguide couples, and/or a camera. Interfaces may include thermal interfaces to control a temperature of a reagent bearing element as described below, such as without limitation a carousel 144, a temperature of a flow cell, and/or temperature of microfluidic pipettes 160. A bottom mechanical interface may control a spindle and/or carousel 144. A plurality of mechanical interfaces on the top of inserted cartridge 100 may be used to control two microfluidic pipettes 160 inside the cartridge 100. Two elements such as syringe pumps in reader 124 may each connect to a microfluidic pipette 160.

Continuing to refer FIG. 1, cartridge 100 includes at least a reagent supply component 136 disposed within the housing 104 and comprising at least a well 140, the at least a well 140 containing at least a reagent. At least a reagent supply component 136 may include a plurality of wells per reagent supply component 136. In an embodiment, reagent supply component 136 and/or the wells therein may hold lyophilized or dried reagents, liquid reagents, a sample to be tested, buffers, and/or other elements and/or ingredients usable and/or necessary for various assay reactions.

Still referring to FIG. 1, at least a reagent supply component 136 may include at least a carousel 144 configured to rotate relative to the housing 104. At least a carousel 144 may include an array of wells in or on a structure that is rotatable relative to housing 104 and/or other portions of cartridge 100. Cartridge 100 may include, and/or be connected to, a rotary motor 148 mechanically coupled to at least a carousel 144. In an embodiment, carousel 144 rotation and/or a pipette 160 arm rotation or both may align different liquids with a pipette 160 arm for functions such as reconstitution, transfer, mixing, aspiration, dispensing, mixing, making dilutions and washing, for instance and without limitation as described below.

Continuing to refer to FIG. 1, cartridge 100 includes a sample source 152 disposed within the housing 104 and containing a biological sample, such as but not limited to blood, plasma, saliva, sweat, urine, digestive fluids, semen, lymph, vaginal secretions, amniotic fluid, cerebrospinal fluid, and/or any other fluids extracted from a biological organism and/or one or more parts or organs thereof. Sample may be provided in a collection tube; for instance, and without limitation, a sample may be extracted from a user and/or patient in collection tube, which may be inserted into cartridge 100, for instance and without limitation as described in disclosures incorporated in this disclosure by reference. Cartridge 100 may include a rotatable spindle, which may include and/or function as a centrifuge for separating plasma from blood for plasma samples. Sample source 152 may include a sample collection port 156, defined as an opening into which a pipette 160 tip may be inserted to collect sample; port may be covered with foil or other frangible seal prior to insertion to prevent sample from leaking out prior to testing procedures, during centrifugation, or the like.

Still referring to FIG. 1, cartridge 100 includes at least a pipette 160 disposed within the housing 104 and having a tip with distal port. At least a pipette 160 includes an internal channel 164 having a proximal end and a distal end. Proximal end is connected to an actuable pressurized fluid supply 168, defined as a fluid supply that has or may provide some pressure to force fluid through internal channel 164 upon actuation, and which may also have a non-actuated state, such as a tank with fluid and pressurized air, a gravitational hydraulic head, and/or one or more pumps; actuation may be accomplished with valves, by stopping and starting pumps such as syringe pumps, or the like, while pressure may be provided via pneumatic pressure, use of an elastic bladder, hydraulic head, one or more pumps including syringe, peristaltic, impeller, or the like.

Cartridge 100 may include and/or be connected to at least a pump fluidically connected to the internal channel 164 of each pipette 160 of the at least a pipette 160. At least a pump may include at least a syringe pump. At least a pump may be operatively connected to control and/or driver circuitry for instance and without limitation as described below. Distal end is connected to the output hole 172; fluid force through channel toward distal end may be forced out of output hole 172, while fluid being forced toward proximal end may be pulled up and/or aspirated into output hole 172. At least a pipette 160 has a suction mode for receiving fluid into the internal channel 164 through distal port and an ejection mode for forcing fluid out of the internal channel 164 through distal port.

Continuing to refer to FIG. 1, the at least a pipette 160 is movable relative to the reagent supply component 136 and the fluidic component 108 between a reagent collection position wherein the distal port is inserted into a well of the at least a well 140 and an ejection position wherein the distal port is inserted into the at least an input port 112, and the at least a pipette 160 is configured to provide the at least a reagent and the biological sample to the at least an input port 112. Where there is a sample collection port 156 at least a pipette 160 may be movable relative to sample collection port 156 to collect a sample, and to deliver that sample to other ports. Relative movement may be achieved by one or more motions of reagent supply component 136, fluidic component 108, and/or pipette 160; as a non-limiting example, pipettes 160 may be fixed while other components move relative to pipettes 160. Alternatively or additionally, relative movement may be performed using a combination motion of pipettes 160 and other elements; for example, a rotary carousel 144 may be combined with a pipette 160 movable between one or more fixed positions over the rotary carousel 144 and one or more fixed positions over input ports 112. Z-axis motion may also be performed by vertical motion of pipette 160 and/or of other elements; for instance, pipette 160 may be raised or lowered relative to other components on a z-axis slide, which may operate similarly to any z-axis control for a computer numerical control (CNC) machine, rapid prototyping device, or the like, and/or a similar device or set of devices may be used to move reagent supply component 136, a carousel 144, sample collection port 156, and/or input ports 112 and/or fluidic component 108 vertically. Although many examples provided herein describe horizontal motion of components in terms of rotary motion, one or more components may alternatively or additionally move linearly in the horizontal plane; for instance, a rotary pipette 160 may be able to access a greater range of wells on a non-rotary reagent supply component 136 that can move toward and away from the axis of rotation of the pipette 160 on a horizontal slide as driven by a linear actuator, while a rotary carousel 144 may be combined with one or more pipettes 160 on a horizontal linear slide, either of which may be combined with any z-axis motion capabilities as described above. Various non-limiting exemplary configurations for motion and arrangement of pipettes 160, reagent supply components 136, and the like are provided below.

Still referring to FIG. 1, pipette 160 arm and/or arms may be used to transfer samples, reagents and buffers within cartridge 100. Pipette 160 arm and/or arms may alternatively or additionally be used for other actions such mixing, dilutions and washing.

Further referring to FIG. 1, a pneumatic connection between elements such as ports and wells and pipettes 160 may allow for fluid to be aspirated and dispensed within cartridge 100. Pipette 160 geometry may include a thin dip tube which accesses fluid within wells and/or pots in reagent supply component 136 and/or carousel 144 by breaking sealing foils that block openings of such wells and/or pots. A cruciform structure on dip tube root may prevent a seal being formed between foil and pipette 160. Air/fluid may be held within the pipette 160 via a winding channel between dip tube and connection spigot; an amount so held may in a non-limiting embodiment be 120 ul. Channel may be monitored from above by sensors and/or sensor arrays such as without limitation 3× IR sensors and/or electrical sensors, each corresponding to a volume of fluid measured from the end of the dip tube; amounts to be aspirated, dispensed, and/or measured by sensors may include, without limitation a range of discrete amounts such as approximately 10 ul, 25 ul, and 100 ul. Pipette 160 may include a blackened mask layer, between the pipette 160 channels and IR sensors, which may restrict a field of view to a narrow slit. When fluid passes IR sensor there may be a change in reading, which may allow active feedback for a volume of fluid within pipette 160. Within a spigot performing pneumatic actions may be included a hydrophobic filter to protect instrument pneumatics from fluid aspiration. Pipette 160 may include and/or be connected to a printed circuit board (PCB) to read out liquid locations in the microfluidic pipette 160. PCB boards may, in non-limiting examples, be part of a reader 124 and reusable or part of disposable cartridge 100.

Still referring to FIG. 1, at least a pipette 160 may include a plurality of pipettes 160. Each pipette 160 of at least a pipette 160 may be configured to rotate around a vertical axis to access one or more of the wells and/or ports as described above. Cartridge 100 may include, and/or be connected to, a rotary motor 148 176 mechanically coupled to the at least a pipette 160. At least a pipette 160 may be configured to move vertically. Cartridge 100 may include and/or be connected to a vertical actuator configured to move the pipette 160 vertically. A vertical actuator 180 may be connected to at least a pipette 160 through a mechanical interface from reader 124 device. Vertical actuator may include any mechanical, pneumatic, hydraulic, and/or electronic device for vertical motion, including without limitation pistons, solenoids, rack-and-pinion assemblies, cable assemblies, or the like.

With continued reference to FIG. 1, components such as pipettes 160, reagent supply component 136, reagent supply carousel 144, and/or other moveable components may include and/or be configured to be connected to an actuator. One or more actuators may be components of a reader 124 device to which cartridge 100 may be connected and/or into which cartridge 100 may be inserted, and such actuator or actuators may be connected to mechanical interfaces on pipettes 160, reagent supply component 136, reagent supply carousel 144 or the like by engagement of clutches, friction fits, clips, gears, or other mechanisms for connections and/or transfer of force. An “actuator” as used herein is a component of a machine and/or mechanical device that is responsible for moving and/or controlling a mechanism or system. An actuator may, in some cases, require a control signal and/or a source of energy or power. In some cases, a control signal may be relatively low energy. Exemplary control signal forms include electric potential or current, pneumatic pressure or flow, or hydraulic fluid pressure or flow, mechanical force/torque or velocity, or even human power. In some cases, an actuator may have an energy or power source other than control signal. This may include a main energy source, which may include for example electric power, hydraulic power, pneumatic power, mechanical power, and the like. In some cases, upon receiving a control signal, an actuator may respond by converting source power into mechanical motion. In some cases, an actuator may be understood as a form of automation or automatic control.

With continued reference to FIG. 1, in some embodiments, actuator may include a hydraulic actuator. A hydraulic actuator may include a cylinder or fluid motor that uses hydraulic power to facilitate mechanical operation. Output of hydraulic actuator may include mechanical motion, such as without limitation linear, rotatory, or oscillatory motion. In some cases, hydraulic actuator may employ a liquid hydraulic fluid. As liquids, in some cases. are incompressible, a hydraulic actuator can exert large forces. Additionally, as force is equal to pressure multiplied by area, hydraulic actuators may act as force transformers with changes in area (e.g., cross sectional area of cylinder and/or piston). An exemplary hydraulic cylinder may consist of a hollow cylindrical tube within which a piston can slide. In some cases, a hydraulic cylinder may be considered single acting. Single acting may be used when fluid pressure is applied substantially to just one side of a piston. Consequently, a single acting piston can move in only one direction. In some cases, a spring may be used to give a single acting piston a return stroke. In some cases, a hydraulic cylinder may be double acting. Double acting may be used when pressure is applied substantially on each side of a piston; any difference in resultant force between the two sides of the piston causes the piston to move.

With continued reference to FIG. 1, in some embodiments, actuator may include a pneumatic actuator. In some cases, a pneumatic actuator may enable considerable forces to be produced from relatively small changes in gas pressure. In some cases, a pneumatic actuator may respond more quickly than other types of actuators, for example hydraulic actuators. A pneumatic actuator may use compressible fluid (e.g., air). In some cases, a pneumatic actuator may operate on compressed air. Operation of hydraulic and/or pneumatic actuators may include control of one or more valves, circuits, fluid pumps, and/or fluid manifolds.

With continued reference to FIG. 1, in some cases, actuator may include an electric actuator. Electric actuator may include any of electromechanical actuators, linear motors, and the like. In some cases, actuator may include an electromechanical actuator. An electromechanical actuator may convert a rotational force of an electric rotary motor 148 into a linear movement to generate a linear movement through a mechanism. Exemplary mechanisms, include rotational to translational motion transformers, such as without limitation a belt, a screw, a crank, a cam, a linkage, a scotch yoke, and the like. In some cases, control of an electromechanical actuator may include control of electric motor, for instance a control signal may control one or more electric motor parameters to control electromechanical actuator. Exemplary non-limitation electric motor parameters include rotational position, input torque, velocity, current, and potential. electric actuator may include a linear motor. Linear motors may differ from electromechanical actuators, as power from linear motors is output directly as translational motion, rather than output as rotational motion and converted to translational motion. In some cases, a linear motor may cause lower friction losses than other devices. Linear motors may be further specified into at least 3 different categories, including flat linear motor, U-channel linear motors and tubular linear motors. Linear motors may be directly controlled by a control signal for controlling one or more linear motor parameters. Exemplary linear motor parameters include without limitation position, force, velocity, potential, and current.

With further reference to FIG. 1, in some embodiments, an actuator may include a mechanical actuator. In some cases, a mechanical actuator may function to execute movement by converting one kind of motion, such as rotary motion, into another kind, such as linear motion. An exemplary mechanical actuator includes a rack and pinion. In some cases, a mechanical power source, such as a power take off may serve as power source for a mechanical actuator. Mechanical actuators may employ any number of mechanism, including for example without limitation gears, rails, pulleys, cables, linkages, and the like.

Still referring to FIG. 1, actuator may be connected to and/or include an electric motor. A “motor”, for the purposes of this disclosure, is a device that converts electrical energy into mechanical movement. Motor may be disposed within or attached to components described in this disclosure. Motor may include, without limitation, any electric motor, where an electric motor is a device that converts electrical energy into mechanical energy, for instance by causing a shaft, such as rotor shaft, to rotate. In one or more embodiments, motor may be driven by direct current (DC) electric power. For instance, motor may include a brushed DC motor. In various embodiments, motor may include, without limitation, a brushless DC electric motor, a permanent magnet synchronous motor, a switched reluctance motor, stepper motor, servo motor, and/or an induction motor. In other embodiments, motor may be driven by electric power having varying or reversing voltage levels, such as alternating current (AC) power, which may be produced by an alternating current generator and/or inverter or by a switching power source. Persons skilled in the art, upon reviewing the entirety of this disclosure, will be aware of various alternative or additional forms and/or configurations that motor may take or exemplify as consistent with this disclosure. In one or more embodiments, motor may be part of a motor assembly, which may also include an inverter, a switching power source, a circuit driving and/or controlling motor, electronic speed controllers, or other components for regulating motor speed, rotation direction, torque, and/or braking. In one or more embodiments, controller may be configured to control and/or operate motor.

Further referring to FIG. 1, components movable using actuators, such as pipette 160 arms, spindle, centrifuge arm, and/or carousel 144 may be journaled on housing 104 and/or other components using one or more bearings, such as collar bearings, ball bearings, needle bearings, or the like. Bearings may include rotary and/or linear bearings; for instance, linear actuation of pipettes 160 and/or a carousel 144 may be supported by linear ball bearings, while rotary motion and/or actuation may be supported by rotary ball bearings.

Continuing to refer to FIG. 1, motion of actuators, or components moved thereby, may be measured using one or more encoders. An “encoder,” as used in this disclosure, is a device or component that measures linear or angular motion of one component relative to another; for instance, a rotary encoder can detect rotation of a pipette 160 arm and/or carousel 144 as measured in radians or degrees, while a linear encoder may detect a distance in millimeters, inches, or the like moved by a pipette 160 and/or carousel 144 using a linear actuator or along a linear slide. Encoders may include optical encoders, which use a light emitter and sensor combination to count passage of apertures in a rotating disc and/or translating strip to detect relative or absolute angular and/or linear displacement, magnetic encoders, which may use Hall effect sensors to detect such displacement, or the like. Encoders may be communicatively connected to circuitry for control as described in further detail below.

Still referring to FIG. 1, to access fluidic component 108 (and/or input port 112), wells and/or pots of reagent supply component 136, and/or sample, a pipette 160 may be raised, lowered and rotated within the cartridge 100. In some embodiments, fluidic component 108 may include a test port 184 for initial alignment; for instance, following engagement, pipette 160 may be rotated to a test port 184 position. As pipette 160 is lowered and holding torque is removed, allowing test port 184 taper to “drag” the pipette 160 into position. Test port 184, or other ports described in this disclosure, may have a large taper. When lowered to the correct height a rotational coordinate system used by circuitry controlling elements of cartridge 100, for example and without limitation as described below and/or in disclosures incorporated by reference, may be zeroed; that is, a current position of pipette 160 may be registered as an origin point or other initial reference point of such a coordinate system. Coordinate system may include without limitation a 3 or more dimensional Cartesian, polar, or other coordinate system. A test port 184 may further be used for pressure testing a system incorporating cartridge 100, such as without limitation pneumatic and/or hydraulic elements of pipette 160 or components connected thereto, to ensure a successful engagement.

Further referring to FIG. 1, fluid is added to fluidic component 108 via inlet ports and/or input ports 112 located on an upper surface thereof, with each lane and/or channel of fluidic component 108 having a dedicated inlet port and/or input port 112. A pipette 160 may be rotated and lowered onto fluidic component 108 until a dip tube engages with input port 112, inlet port or injection port. Downward application of force may create ring seal between input port 112 and/or inlet port and pipette 160. Downward force of up to approximately 20N may be used to form the seal.

Still referring to FIG. 1, when fluid is dispensed from the pipette 160 through the inlet port, fluid may pass to a short channel on the cell underside, which may be referred to as a pre-chip channel. An up-and-over via may then be used to pass fluid from pre-chip channel to channels in a surface of fluidic component 108. When driven down, pipette 160 may form a seal with the fluidic component 108 to allow fluid to be dispensed and aspirated between the two components. Seal may be formed between a ring on the pipette 160 tip and a cone face in the dip tube.

With further connection to FIG. 1, cartridge 100 may include and/or be connected to a control circuit 188, such as without limitation a control circuit 188 located in a reader 124 device or other device to which cartridge 100 is connected and/or into which cartridge 100 is inserted. Control circuit 188 may include circuitry such as without limitation a processor communicatively connected to a memory; for instance, circuitry may include and/or be included in a computing device. Memory may contain instructions configuring processor to perform any method, method steps, and/or combinations thereof as described in this disclosure. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure. Circuitry may include analog circuits and/or analog computational circuits such as without limitation operational amplifier circuits.

With continued reference to FIG. 1, control circuit 188ry may be designed and/or configured to perform any method, method step, or sequence of method steps in any embodiment described in this disclosure, in any order and with any degree of repetition. For instance, control circuit 188ry may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. control circuit 188ry may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, control circuit 188 may be configured to operate cartridge 100 to perform one or more steps. For instance, and without limitation, control circuit 188 may operate motors and/or actuators controlling at least a pipette 160 to perform one or more steps, including without limitation z-axis or vertical movement, rotation, horizontal linear motion, or the like. Control circuit 188 may operate pumps and/or valves to ingest and/or aspirate liquids into at least a pipette 160 or force liquids out of at least a pipette 160. Where at least a reagent supply component 136 includes at least a carousel 144 or other element movable using motors and/or actuators, control circuit 188 may control such motors and/or actuators to move such carousel 144 or other element. Where sample source 152 includes an element movable using motors and/or actuators, control circuit 188 may control such motors and/or actuators to move such element.

As a non-limiting example, and still referring to FIG. 1, control circuit 188 may use at least a pipette 160 to obtain a sample from sample source 152 by rotating and/or sliding at least a pipette 160 into a position over a sample collection port 156, extending at least a pipette 160 down into the sample collection port 156 and/or moving sample collection port 156 vertically upward so that at least a pipette 160 is extended into sample collection port 156, optionally ejecting fluid into sample collection port 156 to mix with a dried or viscous sample, and aspirating a liquid and/or mixed sample into at least a pipette 160. Collection of reagents may similarly be performed by rotating and/or sliding at least a pipette 160 into a position over at least a well 140, and/or rotating or otherwise moving reagent supply component 136, i.e. a carousel 144 so that at least a well 140 is positioned beneath at least a pipette 160, extending at least a pipette 160 down into the at least a well 140 and/or moving at least a reagent supply component 136 vertically upward so that at least a pipette 160 is extended into at least a well 140, optionally ejecting fluid into at least a well 140 to mix with a dried or viscous reagent, and aspirating a liquid and/or mixed reagent into at least a pipette 160. Control circuit 188 may insert at least a pipette 160 into input port 112 by rotating and/or sliding at least a pipette 160 into a position over at least an input port 112, and extending at least a pipette 160 down into the at least an input port 112. Washing of fluidic element may include ejection of fluid from at least a pump or other actuable pressurized fluid supply 168 into fluidic element, and thence out through a waste ejection port and/or followed by aspiration of fluid into at least a pipette 160 to be rotated and/or slide over a waste reservoir 132 for ejection. Placement of samples and/or reagents into fluidic component 108 may include use of pumps and/or actual fluid supplies to force liquid and/or mixed sample and/or reagent out into input port 112 and thus into fluidic channels, sensor chambers 120, or the like.

Further referring to FIG. 1, in some embodiments, and by way of example, control circuit 188 may be configured to obtain a first sample from the sample source 152, insert the first sample into an input port 112 of the at least an input port 112, extract a first reagent from the at least a reagent supply component 136, and insert the first reagent to into the input port 112; such steps may be preceded and/or followed by washing steps as described above, extraction and placement in input port 112 of one or more second or additional samples, extraction and placement input port 112 of one or more second or additional reagents, or the like, for instance and without limitation as described in further detail below. For instance, and without limitation, control circuit 188 may be configured to operate the at least a pipette 160 to wash out a flow channel 116 of the at least a flow channel 116, wherein the flow channel 116 is fluidically connected to the inlet port, operate the at least a pipette 160 to extract a second reagent from the at least a reagent supply component 136, and operate the at least a pipette 160 to insert the second reagent to into the input port 112. Any such steps may be performed in any order.

Continuing to refer to FIG. 1, control circuit 188 may be communicatively connected to the reader 124 device and control circuit 188 may be further configured to detect at least an analyte, using the reader 124 device, in a sensor chamber 120 of the at least a sensor chamber 120, wherein the sensor chamber 120 is fluidically connected to the input port 112; alternatively or additionally, reader 124 device may have a separate circuit, which may include any type of circuitry suitable for use as control circuit 188 and may be communicatively connected to control circuit 188, which is configured to perform analyte detection. Analyte detection may be performed, without limitation, as described in any disclosure incorporated by reference herein.

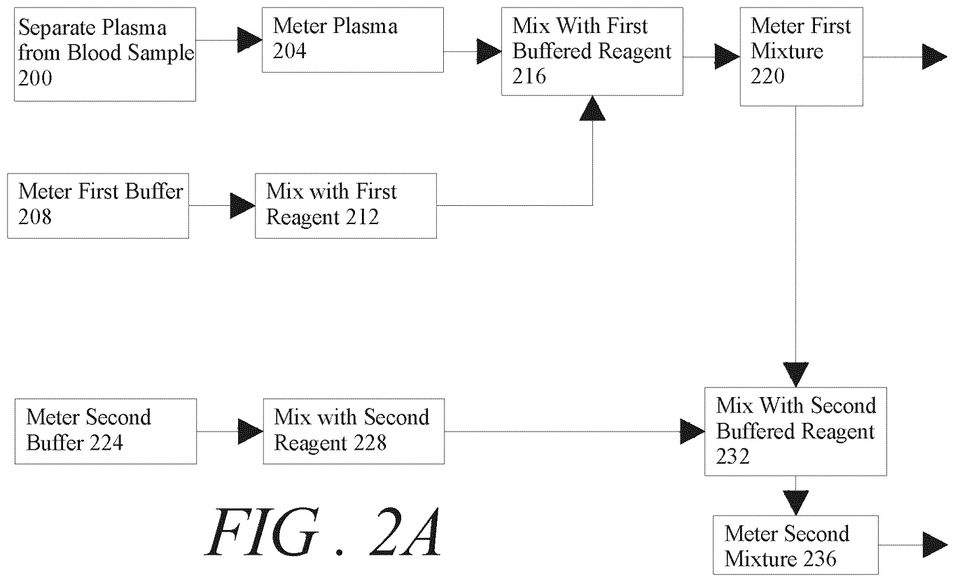

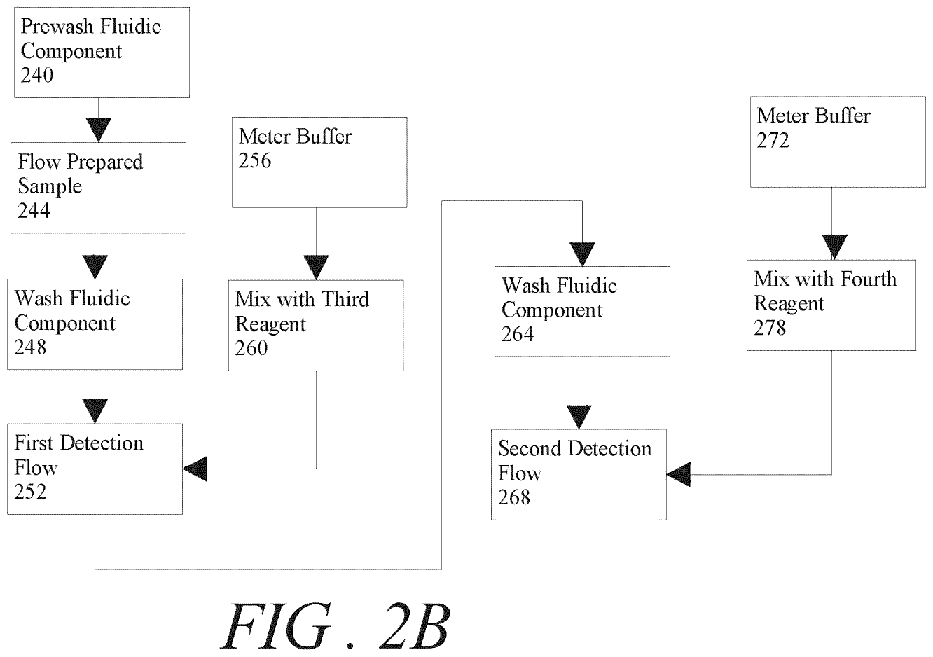

Now referring to FIG. 2A, a non-limiting exemplary block diagram of the microfluidic architecture of a cartridge 100 as described in this disclosure is illustrated, with exemplary embodiments of sample preparation steps. Each step listed may be performed by a control circuit as described in this disclosure and/or by manual or motorized operations. At step 200, a blood sample may be processed to separate plasma; this may be performed, without limitation, by centrifuging the blood sample. Alternative or additional fluid sample preparation steps may also be performed consistently with this disclosure. At step 204, a plasma sample, or other liquid sample, may be metered; this may be performed, without limitation, using one or more pipettes as described above, where metering includes extracting and/or aspirating an estimated or measured amount of the fluid in question, using as a non-limiting example measurement and/or extraction techniques as described in this disclosure. Metered amount may be any suitable amount, such as an amount ranging from approximately or exactly 1 microliter to approximately or exactly 50 microliters, where “exactly” indicates exactly within tolerances recognized as minimal by persons skilled in the art. Extracted sample may additionally be diluted using a buffer; buffer may be extracted from a well in reagent source component in liquid form, extracted by mixing metered fluid from actuable pressurized fluid source with lyophilized material and/or beads in a well, or the like. Each buffer used in processes described herein may include a distinct buffer solution from other buffers and/or an identical buffer solution to one or more buffers used in other buffering steps. Dilution may include any suitable amount of dilution from 2× to 100× dilution; final volume after dilution may be approximately or exactly 100 microliters. In some embodiments, dilution and/or addition to sample may include metering a first buffer 208. Dilution and/or addition to sample may include mixing of first buffer 208 with a reagent 212, for instance and without limitation by mixing first buffer in a well with a liquid, lyophilized, and/or lyophilized pill reagent.

Still referring to FIG. 2A, a resulting first mixture may be metered 220, for instance and without limitation by expelling some volume into waste reservoir. Metered first mixture may be used for provision of sample to fluidic component and/or may be combined with additional buffer and/or reagents. For instance, combination may include metering a second buffer 224. Combination may include mixing of second buffer with a second reagent 228, for instance and without limitation by mixing first buffer in a well with a liquid, lyophilized, and/or lyophilized pill reagent. Second buffer and/or combination of second buffer with second reagent may be combined with first mixture 232 and metered and/or used as before. It is contemplated that one or a plurality of additional combination steps with buffers and/or reagents may be repeated, either in between provisions of samples to fluidic components and/or prior thereto. Sample preparation steps may be repeated by the same or distinct pipettes, for instance and without limitation for each of a plurality of analyte detection operations.

Now referring to FIG. 2B, a non-limiting exemplary block diagram of the microfluidic architecture of a cartridge 100 as described in this disclosure is illustrated, wherein steps for fluidics applications are provided. At step 240, a pipette may be used to prewash a fluidic component by flowing fluid through the component; this may include, e.g., insertion of pipette tip into an inlet port followed by flowing fluid out of distal port of pipette. Prewash may include prewash with a buffer, which may be prepared, e.g., by mixing fluid with a buffer fluid and/or lyophilized buffer as described above. Prewash may be performed over a period of minutes such as approximately 2-5 minutes, and/or with a volume of fluid and/or buffer such as approximately 100 microliters. At step 244, a pipette may be used to flow a sample through fluidic component via inlet port; preparation of sample may be performed, without limitation, using processes, components, and/or process steps as described above. Sample may be flowed and/or left in fluidic component for a period of time to permit, e.g., surface chemistry to take place; time period may be approximately 5-15 minutes. Volume of prepared sample may be approximately 100 microliters, as a non-limiting example. At step 248, pipette may be used to wash, which may use similar times and/or volumes to prewash as described above. At step 252, a reagent and/or reagent mixture may be flowed through fluidic component for a first detection flow; flow may use a volume of, without limitation 100 microliters and/or flow and/or rest in fluidic component for a period of approximately 5-15 minutes. Detection flow may include combination of a metered buffer 256, as described above, with a third reagent 260; for instance, approximately 100 milliliters of buffer may be mixed with liquid, lyophilized, and/or lyophilized bead reagent. The above wash, sample provision, and/or detection steps may be repeated in one or more combinations one or a plurality of times per fluidic channel. For instance, at step 264, pipette may be used to wash, which may use similar times and/or volumes for washes as described above. At step 268, a reagent and/or reagent mixture may be flowed through fluidic component for a second detection flow; flow may use a volume of, without limitation 100 microliters and/or flow and/or rest in fluidic component for a period of approximately 5-15 minutes. Second detection flow may be performed without an intervening sample flow, and/or may be preceded with one or more of sample flow and another wash. Second detection flow may include combination of a metered buffer 272, as described above, with a fourth reagent 278; for instance, approximately 100 milliliters of buffer may be mixed with liquid, lyophilized, and/or lyophilized bead reagent.

Still referring to FIG. 2B, each and/or any of the above processes and/or process steps may be repeated serially or in parallel for two or more channels; for instance, processes and/or process steps may be repeated for each of four channels.

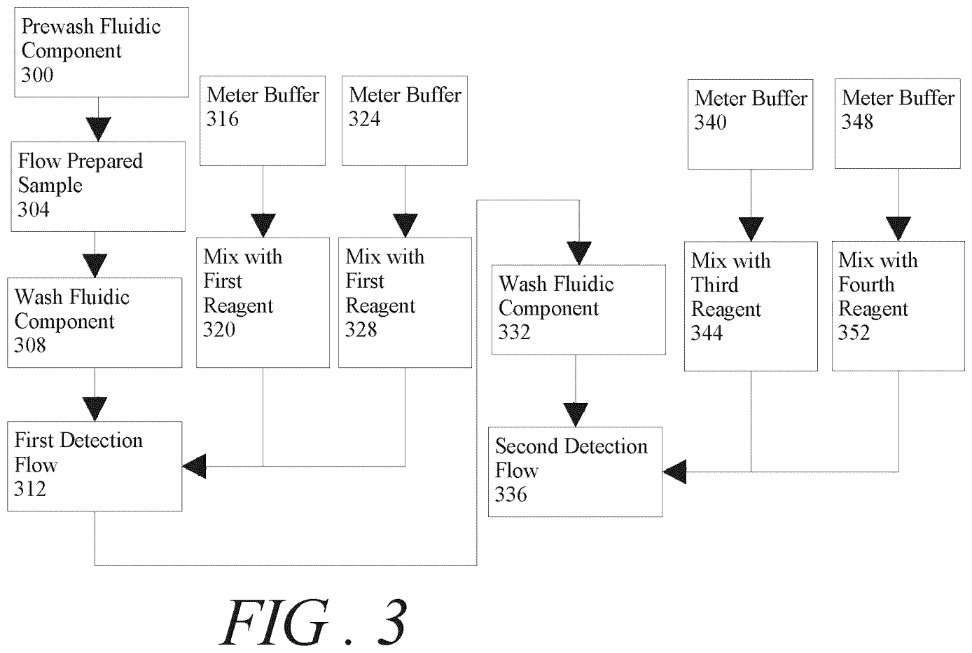

Now referring to FIG. 3, a non-limiting exemplary block diagram of the microfluidic architecture of a cartridge 100 as described in this disclosure is illustrated, wherein steps for fluidics applications are provided. At step 300, a pipette may be used to prewash a fluidic component by flowing fluid through the component; this may include, e.g., insertion of pipette tip into an inlet port followed by flowing fluid out of distal port of pipette. Prewash may include prewash with a buffer, which may be prepared, e.g., by mixing fluid with a buffer fluid and/or lyophilized buffer as described above. Prewash may be performed over a period of minutes such as approximately 2-5 minutes, and/or with a volume of fluid and/or buffer such as approximately 100 microliters. At step 304, a pipette may be used to flow a sample through fluidic component via inlet port; preparation of sample may be performed, without limitation, using processes, components, and/or process steps as described above. Sample may be flowed and/or left in fluidic component for a period of time to permit, e.g., surface chemistry to take place; time period may be approximately 5-15 minutes. Volume of prepared sample may be approximately 100 microliters, as a non-limiting example. At step 308, pipette may be used to wash, which may use similar times and/or volumes to prewash as described above. At step 252, a set of two or more reagents and/or reagent mixtures may be flowed through fluidic component for a first detection flow; flow may use a volume of, without limitation 100 microliters and/or flow and/or rest in fluidic component for a period of approximately 5-15 minutes. Detection flow may include combination of a metered buffer 316, as described above, with a first reagent 320; for instance, approximately 100 milliliters of buffer may be mixed with liquid, lyophilized, and/or lyophilized bead reagent. Detection flow may include combination of a second metered buffer 324, as described above, with a second reagent 328; for instance, approximately 100 milliliters of buffer may be mixed with liquid, lyophilized, and/or lyophilized bead reagent. First and second reagent mixtures may be combined in a well by expulsion of both into the well followed by aspiration; alternatively or additionally, first and second reagent combination may be flowed in series. The above wash, sample provision, and/or detection steps may be repeated in one or more combinations one or a plurality of times per fluidic channel. For instance, at step 332, pipette may be used to wash, which may use similar times and/or volumes for washes as described above. At step 336, a set of two or more reagents and/or reagent mixtures may be flowed through fluidic component for a second detection flow; flow may use a volume of, without limitation 100 microliters and/or flow and/or rest in fluidic component for a period of approximately 5-15 minutes. Second detection flow may be performed without an intervening sample flow, and/or may be preceded with one or more of sample flow and another wash. Second detection flow may include combination of a third metered buffer 340, as described above, with a third reagent 344; for instance, approximately 100 milliliters of buffer may be mixed with liquid, lyophilized, and/or lyophilized bead reagent. Second detection flow may include combination of a fourth metered buffer 348, as described above, with a third reagent 353; for instance, approximately 100 milliliters of buffer may be mixed with liquid, lyophilized, and/or lyophilized bead reagent. Third and fourth reagent mixtures may be combined in a well by expulsion of both into the well followed by aspiration; alternatively or additionally, first and second reagent combination may be flowed in series.

Still referring to FIG. 3, each and/or any of the above processes and/or process steps may be repeated serially or in parallel for two or more channels; for instance, processes and/or process steps may be repeated for each of four channels.

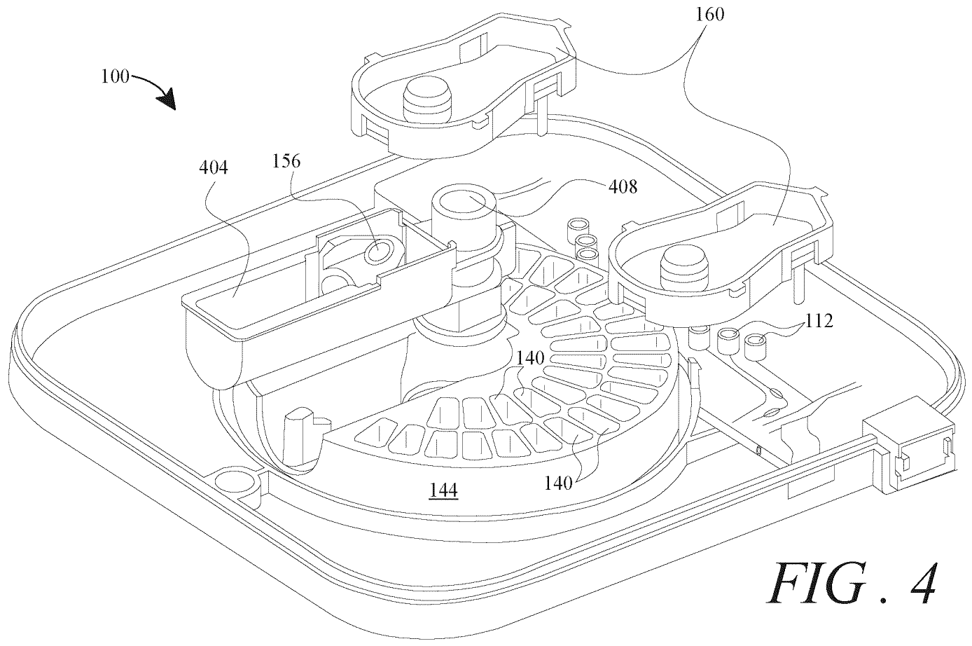

Now referring to FIG. 4, a perspective partial cutaway depiction of an exemplary embodiment of cartridge 100, showing a reagent carousel 144 144, two pipette 160 arms 160, and a sample source 152 support arm 404 capable of, e.g., accepting a sample collection tube, which may be mounted to a central spindle 408 for centrifugation, e.g. to separate blood from plasma or the like. Spindle 408 may also be used to rotate sample carousel 144 144, and may be selectively engaged thereto, e.g. using a vertical clutch mechanism. Multiple input ports 112 112 are shown in an arcuate array permitting a rotary pipette 160 arm to reach each such port.

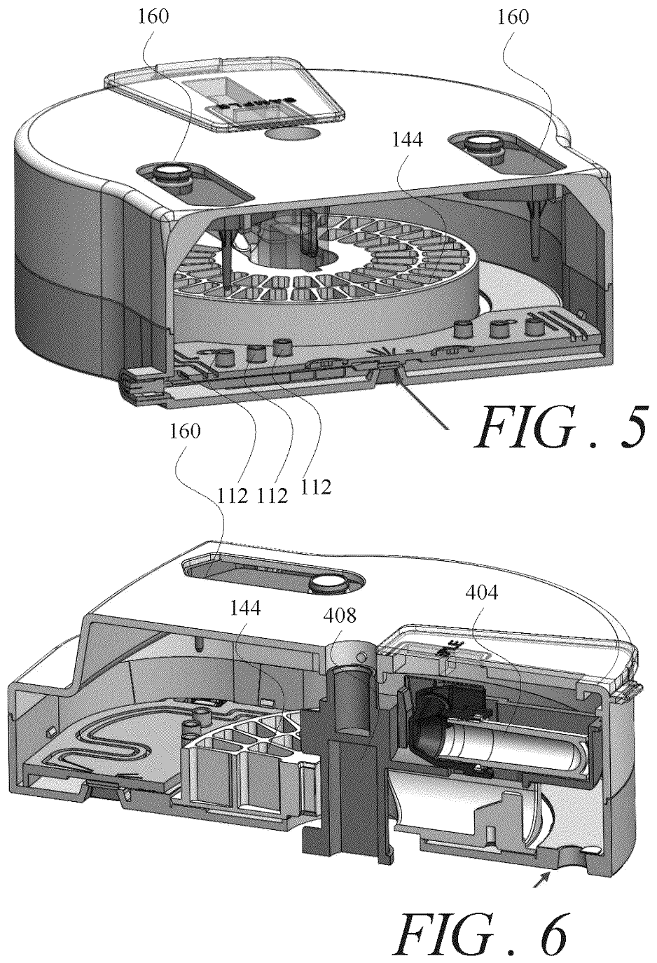

FIG. 5 illustrates a partial cutaway of an embodiment of carousel 144 100 showing pipettes 160 160 with openings above them for connection to motors and/or linear actuators as described above.

FIG. 6 illustrates a cross section of a cartridge 100 with carousel 144 144 showing an arm 404 for centrifugation and a spindle 408 for rotation of arm 404 and/or carousel 144.

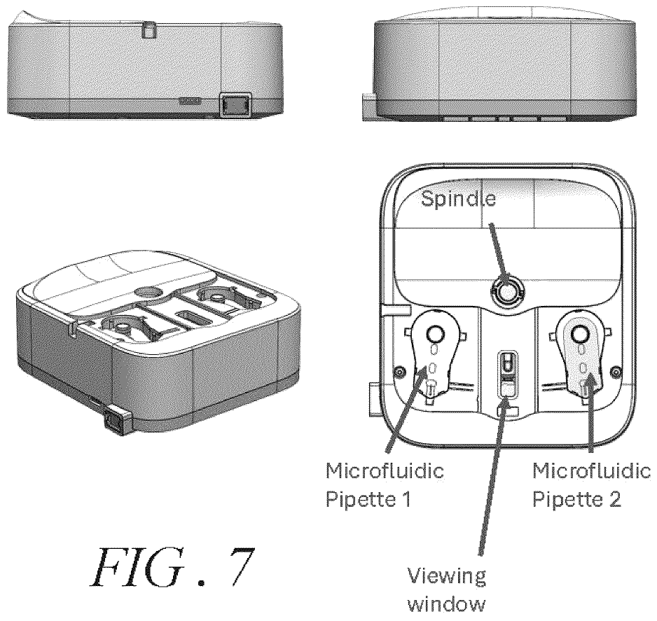

FIG. 7 illustrates exterior views of an exemplary embodiment showing top and side surfaces with interfaces for actuator and/or motor connections.

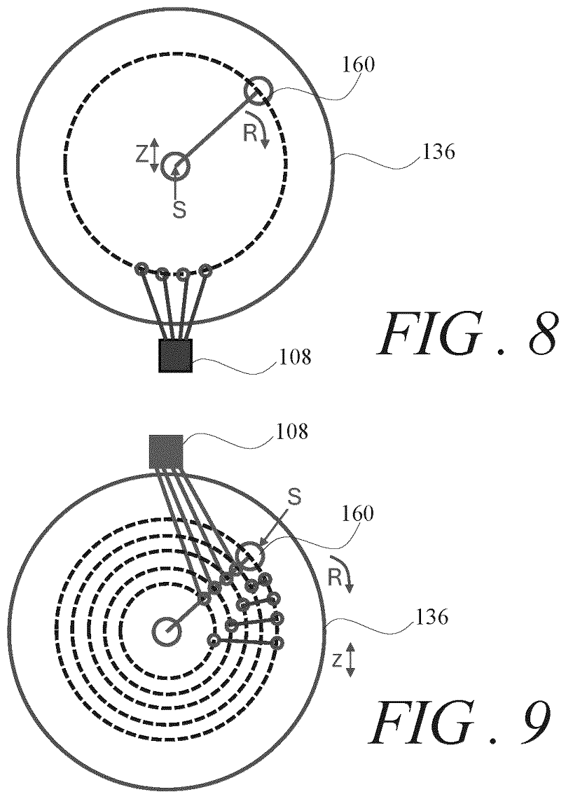

Referring generally to FIGS. 8-32, various exemplary configurations of cartridge 100 are illustrated. In FIGS. 8-32, reagent supply component 136, which may be or include a reagent carousel 144 in some embodiments, is illustrated as a solid circle or circular arc with dotted lines disposed therein illustrating potential curves along which wells may be located. Exemplary embodiments of fluidic component 108 are depicted as a square connected by lines, representing fluidic channels, to small circles representing input ports 112. Indicators R, Z, and S represent, respectively motors and/or actuators, for instance as described above, for rotation and/or direction of rotation, moveability through the Z axis (i.e., vertically), and location of a spindle on which one or more components may rotate.

FIG. 8 shows an exemplary microfluidics architecture with a fixed circular reagent carousel 144 and wells located on the black dotted line therein. A pipette 160 that is driven by a pump or other actuable pressurized fluid supply 168, e.g. a syringe pump, may rotate around an axis and may be moveable in an up and down direction to for example aspirate and dispense liquids into wells. The small circles are fluidic component 108 input ports 112 and the fluidic component 108 is the indicated square. Output ports of the fluidic component 108 are not shown and go to a waste chamber.

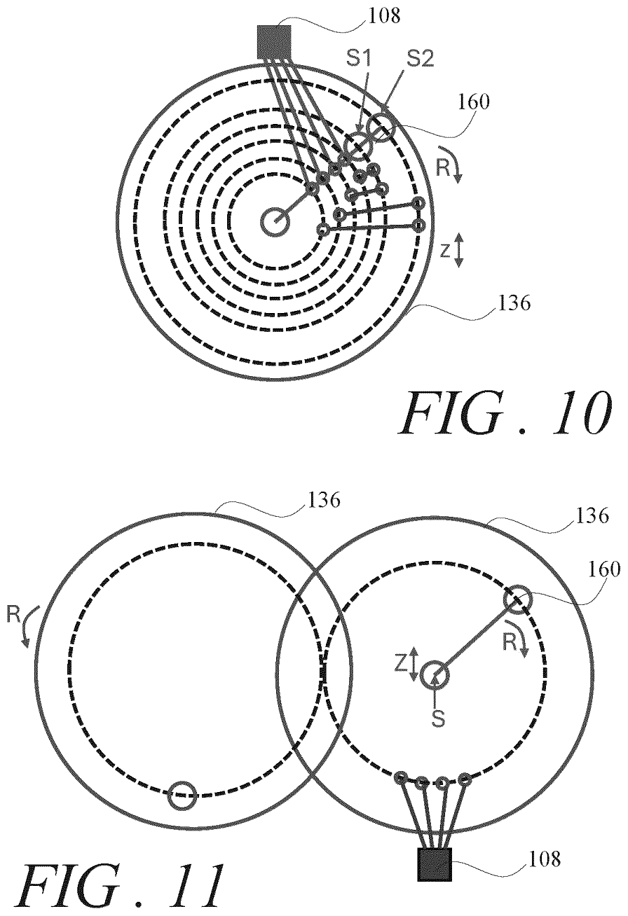

FIG. 9 shows an exemplary embodiment with a rotating and up-down moving carousel 144 of wells and a fixed pipette 160 that addresses 1 circle of wells. Pipette 160 arm also contains the four input ports 112 to the fluidic component 108. Pipette 160 may inject liquids into the input ports 112 by using the fluidic lanes that connect the pipette 160 and the fluidic component 108 input ports 112 through the carousel 144. An advantage of this architecture may include the ability of the reagent carousel 144 to spin and thus act as for example a well mixer or a centrifuge. Fluidic lines to the pipette 160 that are fixed in this example may be easier to engineer and/or manufacture.

FIG. 10 illustrates an exemplary architecture which is the same architecture as FIG. 9, except that two pipettes 160 are mounted to the pipette 160 arm, such that two well circles can be addressed. In some embodiments, this may enable simultaneous operation of two procedures simultaneously using the two pipettes 160.

FIG. 11 illustrates an exemplary embodiment which includes a combination of a rotating carousel 144 and a fixed carousel 144. A pipette 160 rotates and moves up and down in the fixed carousel 144, and can address fluidic component 108 input ports 112. The pipette 160 has also access to wells of the rotating carousel 144 (where the black dotted lines intersect), which can rotate wells into reach of the pipette 160.

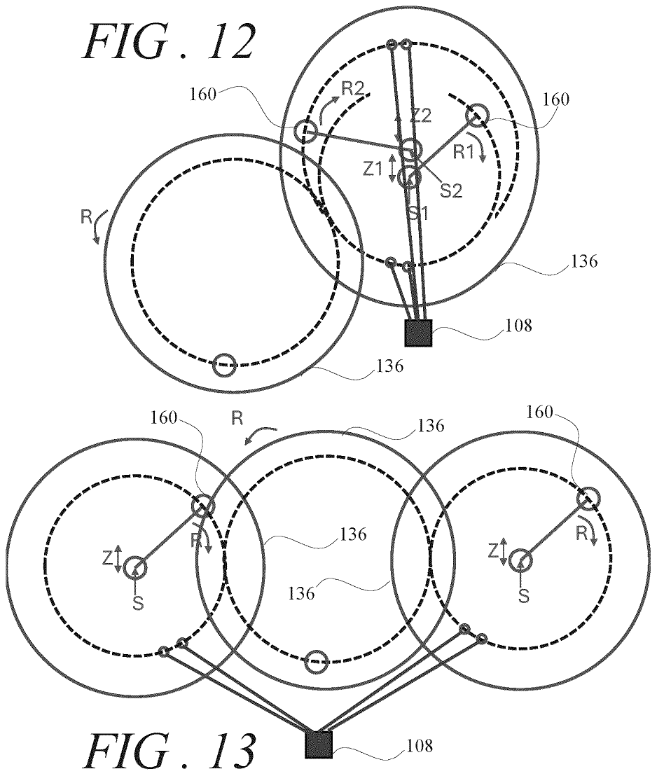

FIG. 12 shows a variation of FIG. 11 but now with two rotating pipettes 160 with offset centers and the same or different rotating radiuses.

FIG. 13 shows a variation of FIG. 11 in which there are two fixed carousels 144, each with a rotating pipette 160 positioned centrally, with a middle rotating carousel 144 positioned therebetween and able to bring wells mounted to it in reach of either pipette 160. Inputs ports to the fluidic component 108 and microfluidic operations can now be addressed in parallel doubling the throughput.

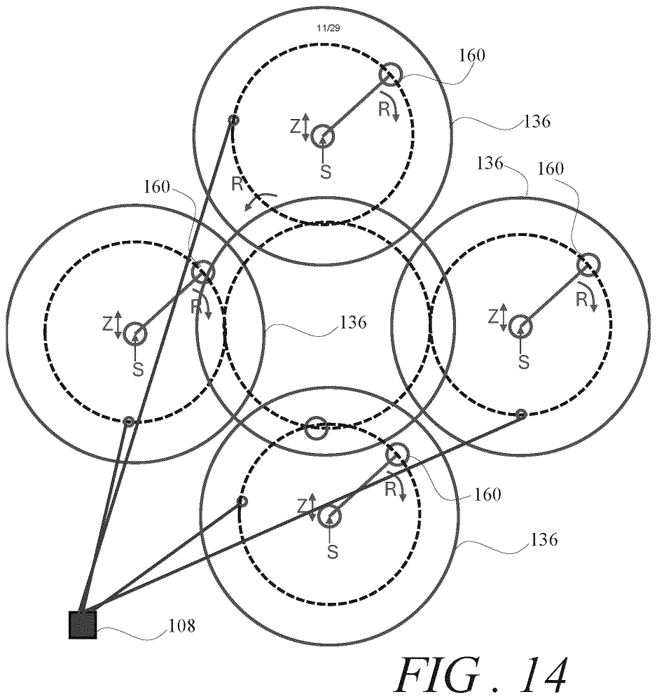

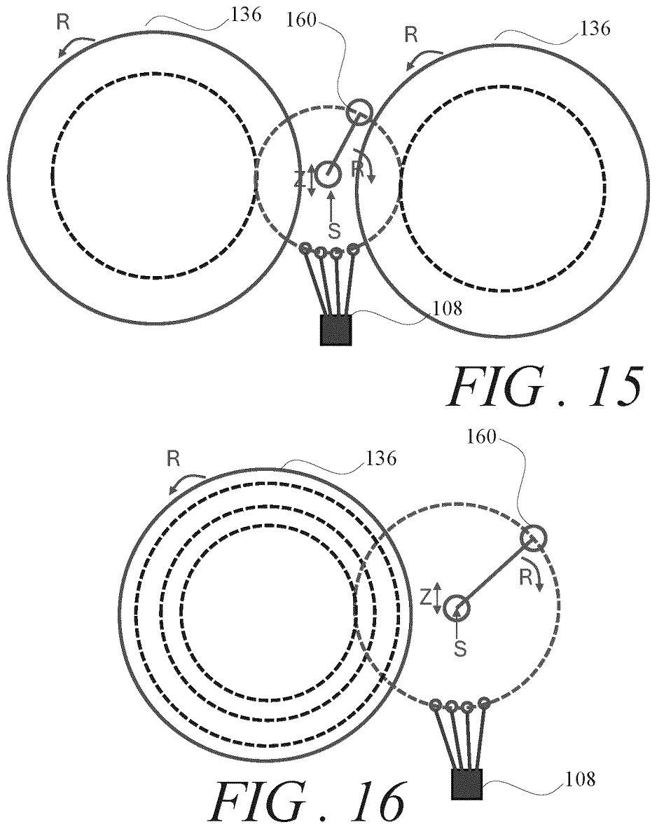

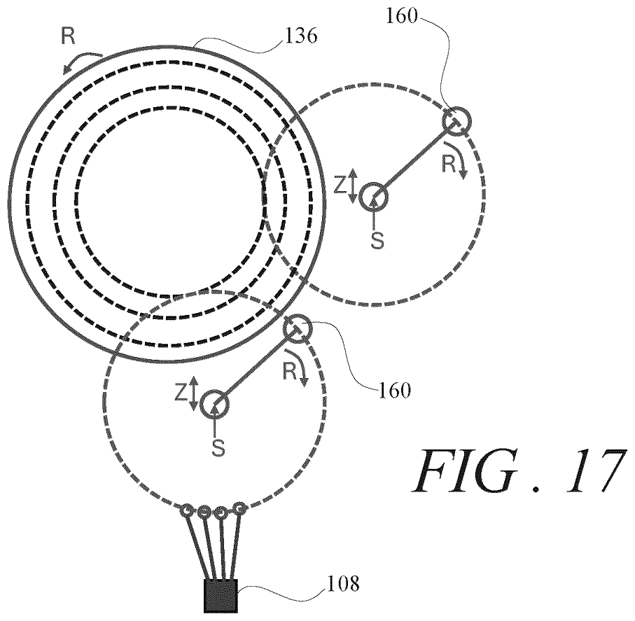

FIG. 14 is a variation of FIG. 13 with four rotating pipettes 160, quadrupling the throughput.

FIG. 15 shows two rotating carousels 144 and a rotating pipette 160 in the middle which can address wells of both rotating carousels 144 and the fixed input ports 112 of the fluidic component 108.

FIG. 16 shows a rotating carousel 144 with multiple well circles and a rotating pipette 160 which can address each well circle of the carousel 144 at the intersection of the black dotted lines and the red dotted line.

FIG. 17 shows a variation of FIG. 16, with the addition of an extra rotating pipette 160 to perform microfluidic steps. In an embodiment, a first pipette 160 such as without limitation the pipette 160 depicted in the upper right of FIG. 17, may include a dilution pipette 160, which may be used to ensure and/or measure sampling accuracy by adding fluid to wells for reconstitution of lyophilized reagents or the like, and/or for mixing samples a series of wells, and a second pipette 160, such as without limitation a pipette 160 depicted in a lower central location of the figure, may be dedicated for supplying samples and/or reagents to fluidic component 108.

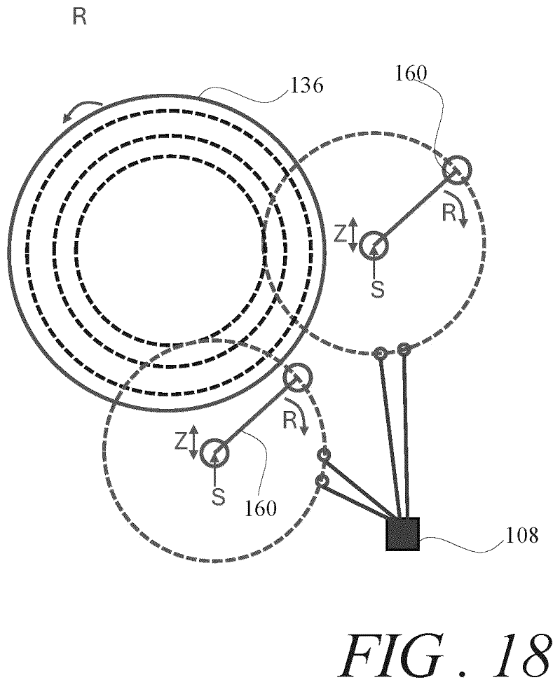

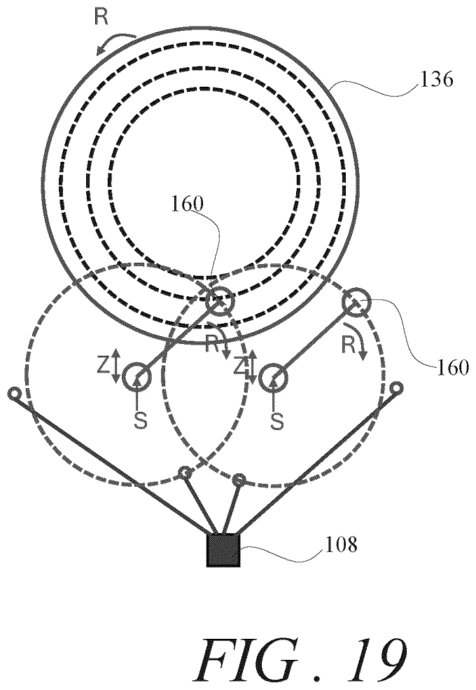

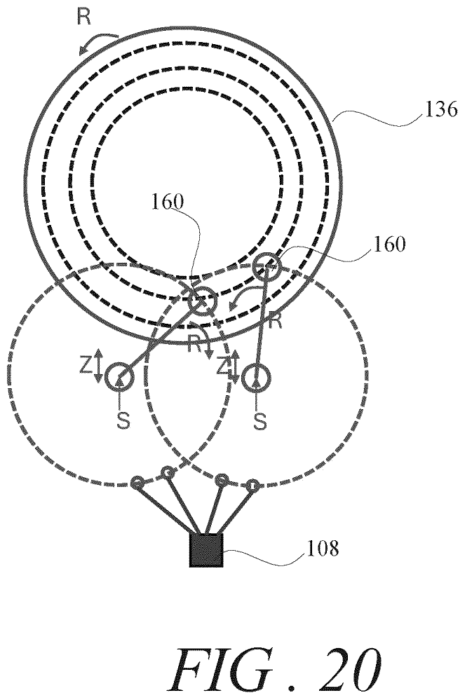

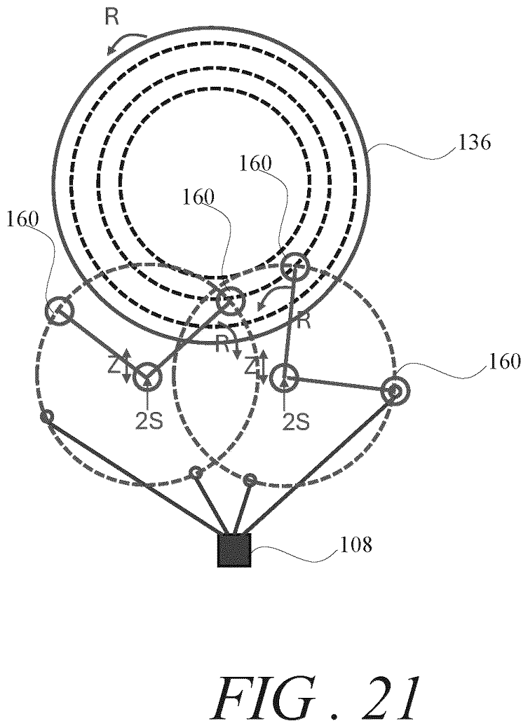

FIG. 18 shows a variation of FIG. 17 where the extra pipette 160 can also address input ports 112 of the fluidic component 108.

FIG. 19 shows a variation of FIG. 18 where the pipettes 160 are placed closer together to reduce the footprint of the disposable cartridge 100. The pipettes 160 can still rotate 360 degrees but need to be controlled, for instance and without limitation by control circuit 188, such that they don't clash; collision avoidance may permit pipettes 160 and/or carousels 144 to be stored more compactly.

FIG. 20 shows a variation of FIG. 19 where the wall of the disposable cartridge 100 is not intersecting with the pipette 160 movement circles. This reduces the footprint even further. Pipettes 160 may be unable to rotate 360 degrees may be rotatable through sufficient degrees of freedom to address all wells and fluidic component 108 ports.

FIG. 21 shows a variation of FIG. 19 where two pipettes 160 are mounted on the same rotation stage. All input ports 112 of the fluidic component 108 may be addressable simultaneously. The pipettes 160 may be angularly spaced such that one pipette 160 can address a well while the other is not dipped into a well.

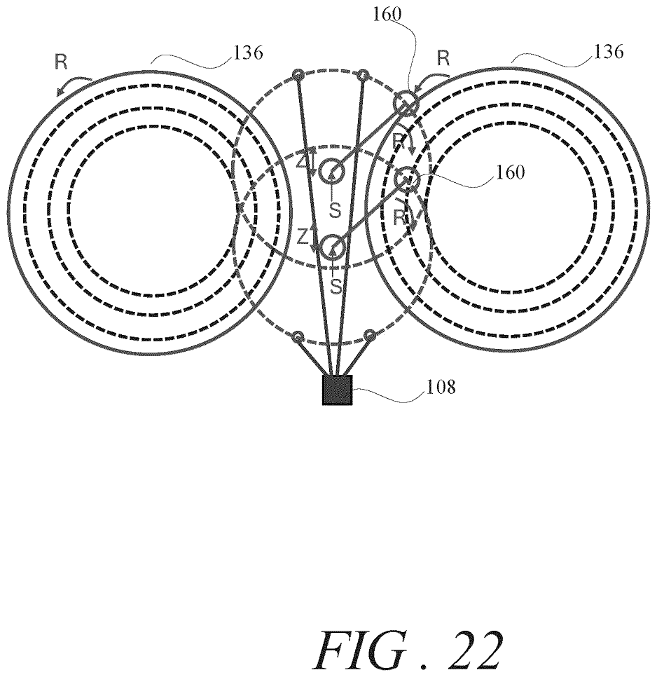

FIG. 22 shows a variation of FIG. 15 but with two pipettes 160 addressing two rotating carousels 144 and where the centers of rotation of the pipettes 160 are within the moving circles of each other reducing the footprint of the disposable cartridge 100. Pipettes 160 may now be unable to rotate through a forbidden angular zone where the center of the other pipette 160 and/or may be mounted at different heights and/or controlled from opposite vertical sides (top/bottom). In an embodiment, additional wells may be located within dotted circles shown for rotational range of pipette 160 arms; this may be possible for any other embodiments described in this disclosure.

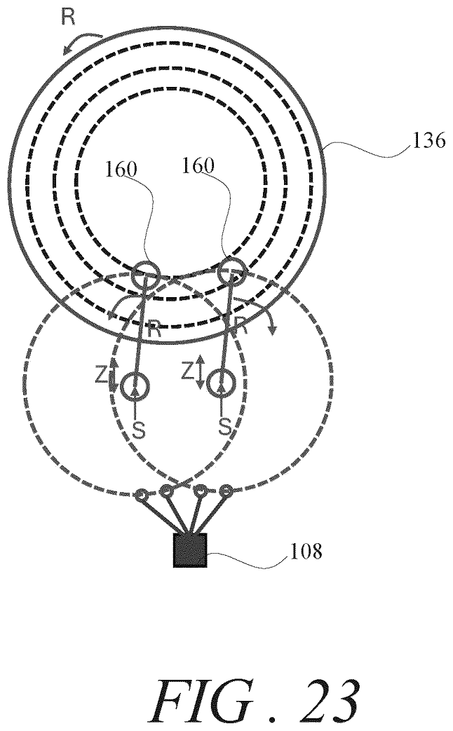

FIG. 23 depicts an exemplary variation of FIG. 20 with the centers of rotation of the pipettes 160 within the moving circle of each other as in FIG. 22, reducing the footprint of the disposable cartridge 100, similarly to embodiments described above, and may use collision avoidance programming as above.

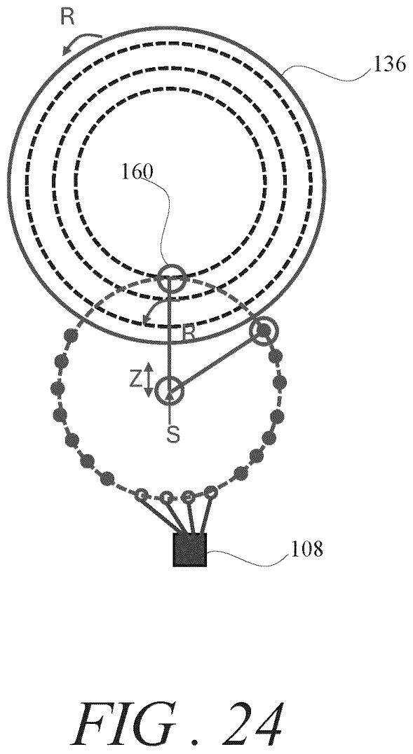

FIG. 24 illustrates an exemplary embodiment in which two pipettes 160 are not only controlled by the same rotation and z stage but also by the same syringe pump. Filled circles depict blocking ports such that a pipette 160 inserted therein is stopped from permitting egress of fluid, such that only one pipette 160 is driven by the syringe pump at any time. This may allow for switching to a different pipette 160 for different operations for example or when the other is at risk for carryover of liquids from a previous step.

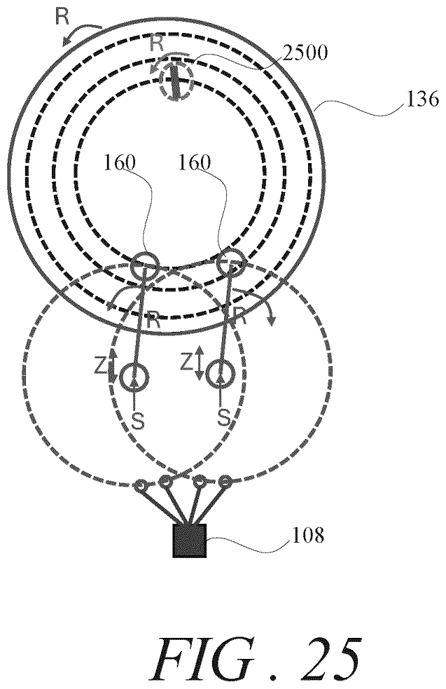

FIG. 25 illustrates an exemplary variation of FIG. 23 wherein a region under or above a rotating carousel 144 has a magnet 2500 which can be used for mixing and/or magnetic separation. Potentially this magnet may also rotate in case of mixing with a stirrer; for instance, a corresponding magnetic element coupled to an electric motor or other rotary actuator may be controlled by control circuit 188 to perform stirring operations. Because the carousel 144 rotates, each well on the well circle that intersects the magnet may be positioned on top of the magnet to perform the required function. Magnet may also include, e.g. an imager or a camera to perform a function or analysis on a well that is positioned on top or underneath it; each well may alternatively or additional contain a magnetic stirrer.

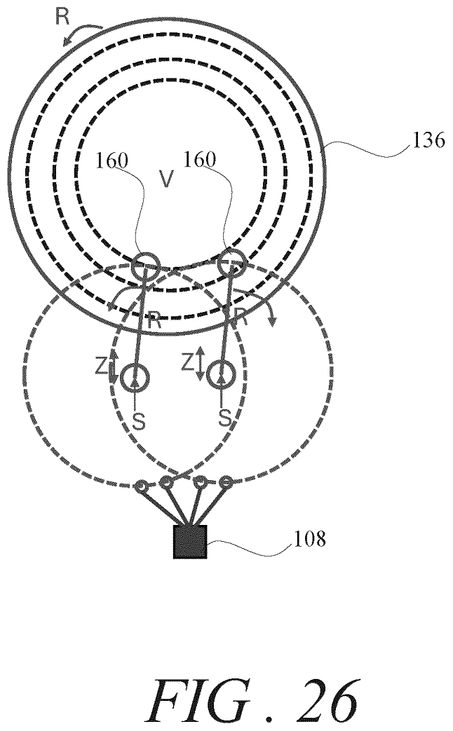

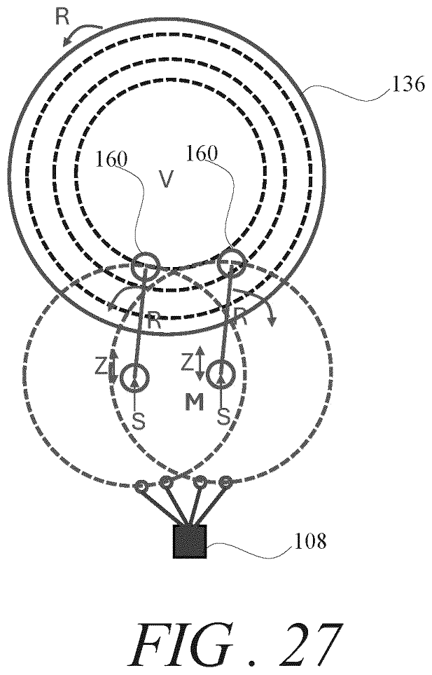

FIG. 26 shows variation of FIG. 23 wherein a reagent carousel 144 is able spin back and forth to perform a vortexing function (denoted V) for mixing of liquid in wells. This may be applied on any of the architectures with a rotating or moving carousel 144. Alternatively, pipette 160 may be movable in a circular or other motion within a well to stir liquid in the well. Stirring using vortexing function may include stir-mix-stir processes wherein a carousel 144 spins, fluid is added to a well, and then the carousel 144 spins a second time to stir contents with liquid.

FIG. 27 shows a variation of FIG. 23 in which one of the pipettes 160 is driven by a more controlled metering syringe (denoted M) or other precision metering pump such as without limitation a MEMS micropump, or the like.

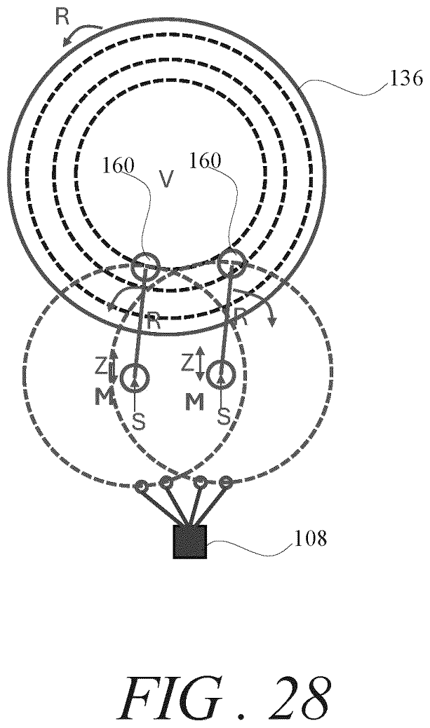

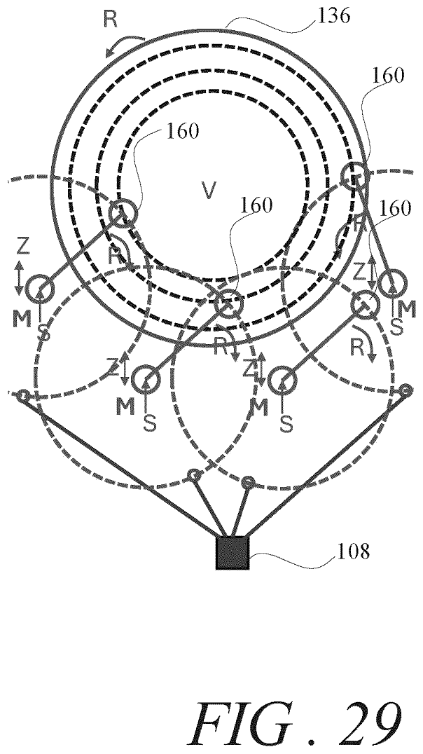

FIG. 28 shows a variation of FIG. 23 including two more precise fluidic pumps to split metering, dilution and mixing functions between the two pipettes 160 to strategically minimize carryover. This embodiment or similar embodiments may be combined with vortex functionality as described above. In some embodiments, use of two metering pipettes 160 may function to minimize carry over impact by using one for small dilutions and another for large dilutions; for instance, volumes and/or resolution of the former may be smaller, and the latter greater.

FIG. 29 illustrates a variation of FIG. 28 that includes two extra pipettes 160, doubling the throughput and without increasing the footprint of the cartridge 100 significantly. Additional pipettes 160 can minimize carryover impact by use of multiple pipettes 160 and/or pumps for distinct functions.

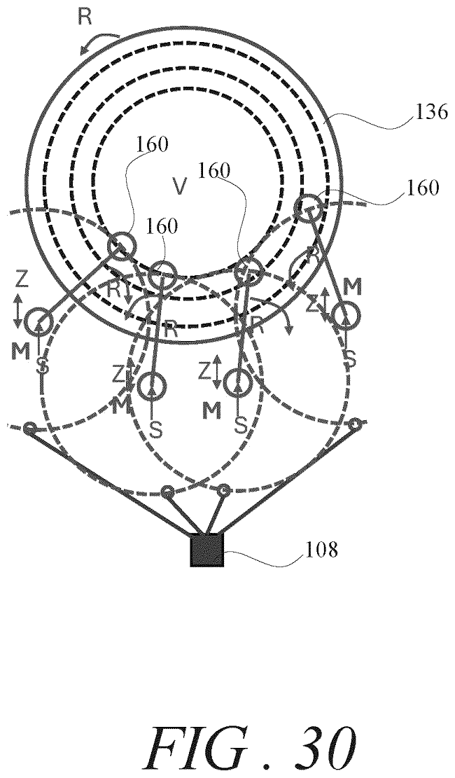

FIG. 30 illustrates a variation of FIG. 29 with a more compact footprint because the pipettes 160 are closer together without reducing the functionality.

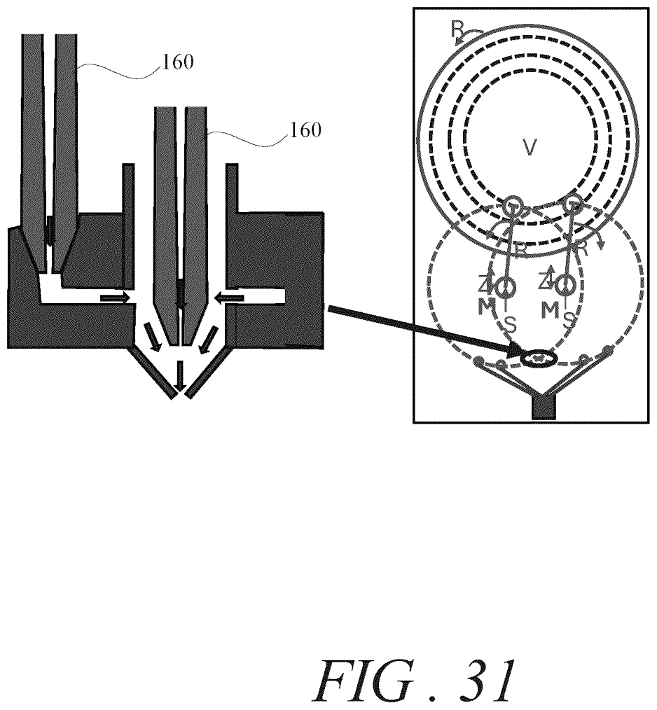

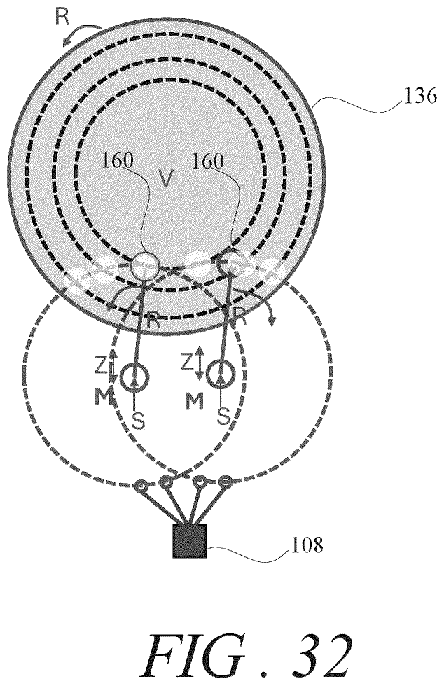

FIG. 31 shows a cross section of a washing station that is compatible with many of the previous architectures. An interior channel of pipette 160 may be washed by aspirating liquid from a well and aspirating it. An outside of pipette 160 may be washed by another pipette 160 injection washing liquid into a port that then sprays the washing liquid onto the outside of the pipette 160 that is being washed from different sides, heights and angles. Contaminated wash liquid flows to a drain, which may connect to a waste reservoir 132 as described above. Washing station may be positioned such that its reachable by either pipette 160; each pipette 160 may be able to wash an exterior of another pipette 160, such that washing station may be able to wash both of a pair of corresponding pipettes 160.

FIG. 32 illustrates a variation of FIG. 28 where there is stationary lid over the carousel 144 with holes in the location where the pipettes 160 interact with the carousel 144. This may minimize evaporation of liquid in the wells during operation.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

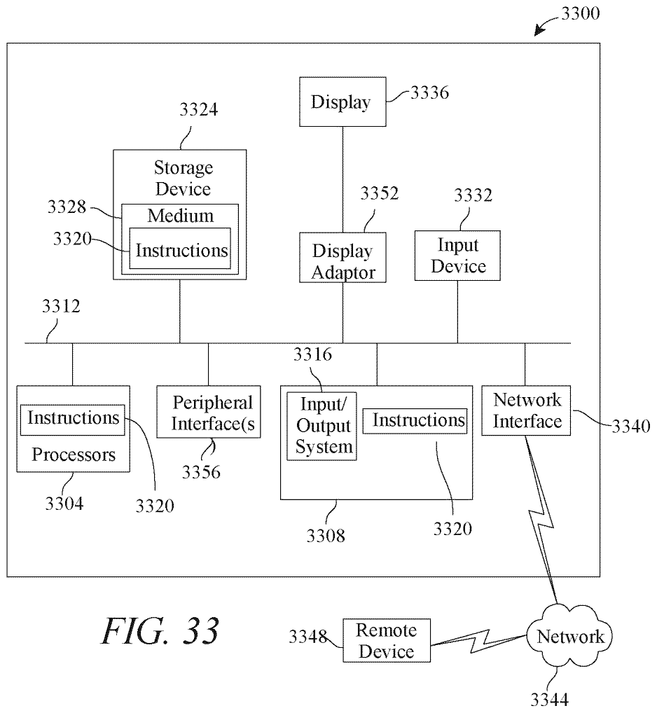

FIG. 33 shows a diagrammatic representation of one embodiment of a computing device in the exemplary form of a computer system 3300 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 3300 includes a processor 3304 and a memory 3308 that communicate with each other, and with other components, via a bus 3312. Bus 3312 may include any of several types of bus structures including, but not limited to, a memory bus, a memory controller, a peripheral bus, a local bus, and any combinations thereof, using any of a variety of bus architectures.

Processor 3304 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 3304 may be organized according to Von Neumann and/or Harvard architecture as a non-limiting example. Processor 3304 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 3308 may include various components (e.g., machine-readable media) including, but not limited to, a random-access memory component, a read only component, and any combinations thereof. In one example, a basic input/output system 3316 (BIOS), including basic routines that help to transfer information between elements within computer system 3300, such as during start-up, may be stored in memory 3308. Memory 3308 may also include (e.g., stored on one or more machine-readable media) instructions (e.g., software) 3320 embodying any one or more of the aspects and/or methodologies of the present disclosure. In another example, memory 3308 may further include any number of program modules including, but not limited to, an operating system, one or more application programs, other program modules, program data, and any combinations thereof. Memory 3308 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 3300 may also include a storage device 3324. Examples of a storage device (e.g., storage device 3324) include, but are not limited to, a hard disk drive, a magnetic disk drive, an optical disc drive in combination with an optical medium, a solid-state memory device, and any combinations thereof. Storage device 3324 may be connected to bus 3312 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 3324 (or one or more components thereof) may be removably interfaced with computer system 3300 (e.g., via an external port connector (not shown)). Particularly, storage device 3324 and an associated machine-readable medium 3328 may provide nonvolatile and/or volatile storage of machine-readable instructions, data structures, program modules, and/or other data for computer system 3300. In some embodiments, storage device 3324 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry 102 may access the information from primary memory. In one example, software 3320 may reside, completely or partially, within machine-readable medium 3328. In another example, software 3320 may reside, completely or partially, within processor 3304.

Computer system 3300 may also include an input device 3332. In one example, a user of computer system 3300 may enter commands and/or other information into computer system 3300 via input device 3332. Examples of an input device 3332 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 3332 may be interfaced to bus 3312 via any of a variety of interfaces (not shown) including, but not limited to, a serial interface, a parallel interface, a game port, a USB interface, a FIREWIRE interface, a direct interface to bus 3312, and any combinations thereof. Input device 3332 may include a touch screen interface that may be a part of or separate from display 3336, discussed further below. Input device 3332 may be utilized as a user selection device for selecting one or more graphical representations in a graphical interface as described above.

A user may also input commands and/or other information to computer system 3300 via storage device 3324 (e.g., a removable disk drive, a flash drive, etc.) and/or network interface device 3340. A network interface device, such as network interface device 3340, may be utilized for connecting computer system 3300 to one or more of a variety of networks, such as network 3344, and one or more remote devices 3348 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 3344, may employ a wired and/or a wireless mode of communication. In general, any network topology may be used. Information (e.g., data, software 3320, etc.) may be communicated to and/or from computer system 3300 via network interface device 3340.

Computer system 3300 may further include a video display adapter 3352 for communicating a displayable image to a display device, such as display 3336. Examples of a display device include, but are not limited to, a liquid crystal display (LCD), a cathode ray tube (CRT), a plasma display, a light emitting diode (LED) display, and any combinations thereof. Display adapter 3352 and display 3336 may be utilized in combination with processor 3304 to provide graphical representations of aspects of the present disclosure. In addition to a display device, computer system 3300 may include one or more other peripheral output devices including, but not limited to, an audio speaker, a printer, and any combinations thereof. Such peripheral output devices may be connected to bus 3312 via a peripheral interface 3356. Examples of a peripheral interface include, but are not limited to, a serial port, a USB connection, a FIREWIRE connection, a parallel connection, and any combinations thereof.

Further referring to FIG. 33, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 33, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 33, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 3300, processor 3304, and memory 3308 may be virtualized; that is, a virtual machine and/or container may interact directly with such computing system 3300, processor 3304, and/or memory 3308, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 3304 comprises a plurality of processors and/or processor cores, virtualization may, in some cases, simulate or emulate a single (virtual) processor whose functions are allocated to one or more of the plurality of processors and/or processor cores. In this case, while processor 3304 may be said to be virtualized, the processor 3304, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A disposable cartridge for a testing device, the cartridge comprising:
a housing;
a fluidic component disposed within the housing, the fluidic component comprising:
at least an input port configured to receive fluid;
at least a flow channel fluidically connected to the at least an input port; and
a sensor chamber fluidically connected to the at least a flow channel, the sensor chamber communicatively connected to a reader device;
at least a reagent supply component disposed within the housing and comprising at least a well, the at least a well containing at least a reagent;
a sample source disposed within the housing and containing a biological sample; and
at least a pipette disposed within the housing and having a tip with distal port, wherein:
the at least a pipette includes an internal channel having a proximal end and a distal end;
the proximal end is connected to an actuable pressurized fluid supply;
the distal end is connected to the output hole;
the at least a pipette has a suction mode for receiving fluid into the internal channel through the distal port and an ejection mode for forcing fluid out of the internal channel through the distal port;
the at least a pipette is movable relative to the reagent supply component and the fluidic component between a reagent collection position wherein the distal port is inserted into a well of the at least a well and an ejection position wherein the distal port is inserted into the at least an input port; and
the at least a pipette is configured to provide the at least a reagent and the biological sample to the at least an input port.

2. The cartridge of claim 1, wherein the at least a flow channel further comprises at least a microfluidic channel.

3. The cartridge of claim 1, wherein the at least a sensor chamber further comprises a plurality of sensor chambers per flow channel.

4. The cartridge of claim 1, wherein the at least a flow channel further comprises a waste fluid outlet port.

5. The cartridge of claim 4, wherein the housing further comprises a waste reservoir fluidically connected to the waste fluid outlet port.

6. The cartridge of claim 1, wherein the at least a reagent supply component comprises a plurality of wells per reagent supply component.

7. The cartridge of claim 1, wherein the at least a reagent supply component further comprises at least a carousel configured to rotate relative to the housing.

8. The cartridge of claim 1 further comprising a rotary motor mechanically coupled to the at least a carousel.

9. The cartridge of claim 1, wherein:
the sample source further comprises a sample collection port; and
the at least a pipette is movable relative to the sample collection port to a sample collection position wherein the distal end is inserted into the sample collection port.

10. The cartridge of claim 1, wherein the at least a pipette comprises a plurality of pipettes.

11. The cartridge of claim 1, wherein the at least a pipette is configured to rotate around a vertical axis.

12. The cartridge of claim 11 further comprising a rotary motor mechanically coupled to the at least a pipette.

13. The cartridge of claim 1, wherein the at least a pipette is configured to move vertically.

14. The cartridge of claim 13 further comprising a vertical actuator configured to move the pipette vertically.

15. The cartridge of claim 1, further comprising at least a pump fluidically connected to the internal channel of each pipette of the at least a pipette.

16. The cartridge of claim 15, wherein the at least a pump further comprises at least a syringe pump.

17. The cartridge of claim 15, wherein the pump is operatively connected to a control circuit.

18. The cartridge of claim 1 further comprising a control circuit, the control circuit configured to operate the at least a pipette to perform steps comprising:
obtaining a first sample from the sample source;
inserting the first sample into an input port of the at least an input port;
extracting a first reagent from the at least a reagent supply component; and
inserting the first reagent to into the input port.

19. The cartridge of claim 18, wherein:
the control circuit is communicatively connected to the reader device; and
the control circuit is further configured to detect at least an analyte, using the reader device, in a sensor chamber of the at least a sensor chamber, wherein the sensor chamber is fluidically connected to the input port.

20. The cartridge of claim 19, wherein the control circuit is further configured to:
operate the at least a pipette to wash out a flow channel of the at least a flow channel,
wherein the flow channel is fluidically connected to the inlet port;
operate the at least a pipette to extract a second reagent from the at least a reagent supply component; and
operate the at least a pipette to insert the second reagent to into the input port.
